(19) United States
(12) Patent Application Publication
(10) Pub. No.: US 2025/0194727 A1
(43) Pub. Date: Jun. 19, 2025

(54) HEADGEAR MOUNT AND IMAGING SYSTEM

(71) Applicant: Maranon, Inc., Eagle Rock, VA (US)

(72) Inventor: James Thomas, Eagle Rock, VA (US)

(73) Assignee: Maranon, Inc., Eagle Rock, VA (US)

(21) Appl. No.: 18/980,870

(22) Filed: Dec. 13, 2024

Related U.S. Application Data
(60) Provisional application No. 63/610,777, filed on Dec. 15, 2023.

(51) Int. Cl. A42B 3/04; A42B 3/32; G02B 23/12

(52) U.S. Cl. CPC A42B 3/042; A42B 3/324; G02B 23/125

(57) ABSTRACT

A headgear mount system includes a mechanical assembly comprising at least one mount assembly, at least one tilt/flip assembly, and at least one interpupillary distance (IPD) adjustment assembly. The mount assembly connects the mechanical assembly to the headgear, while the tilt/flip assembly rotatably connects the IPD adjustment assembly to the mount assembly. The tilt/flip assembly includes at least one tilt/flip pin rotatably interconnecting the mount assembly and the IPD adjustment assembly. The tilt/flip pin allows rotation of the IPD adjustment assembly relative to the mount assembly to permit the electro-optical assembly mounted to the IPD adjustment assembly to be stowed out of the way when not in use.

### CROSS-REFERENCE TO RELATED APPLICATIONS

This application claims the benefit of prior-filed, co-pending U.S. Provisional Patent Application No. 63/610,777, filed on Dec. 15, 2023, the contents of which are incorporated herein by reference in their entirety.

### BACKGROUND OF THE INVENTION

The present application is directed to the field of imaging. More specifically, the present application is directed to the field of military and commercial imaging devices.

Field imaging devices, particularly those used by the military, have generally been locked in an architecture that results in a heavy product. When mounted on headgear, such as a helmet or band, the result is physiological neck strain, pain, loss of attentiveness, and potential injury. These devices are often slow and difficult to remove when unneeded, and adjustment of collimation and interpupillary distance (IPD) may be equally cumbersome. As a result, most users use handheld imaging devices. This, however, reduces the number of hands available for other tasks, which may present an unacceptable risk during combat or physical activity. Furthermore, users are often unable to customize the imaging sensors, requiring the use of multiple monocular imaging devices for different sensing modes. This exacerbates the problems of handling other gear.

There is an unmet need in the art for a headgear mounting system that allows easy stowing and adjustment of imaging devices.

### BRIEF SUMMARY OF THE INVENTION

The present application is for a headgear mount system. This system includes a mechanical assembly having at least one mount assembly and at least one tilt/flip assembly. The at least one mount assembly connects the mechanical assembly to a headgear. The at least one tilt/flip assembly rotatably connects to at least one electro-optical assembly. The at least one tilt/flip assembly includes at least one tilt/flip pin interconnecting the at least one mount assembly and the at least one electro-optical assembly. The at least one tilt/flip pin extends through at least one carriage connector of the at least one mount assembly and at least one pivot cylinder connected to the at least one electro-optical assembly.

The at least one mount assembly may include a right mount assembly and a left mount assembly.

The at least one mount assembly may include at least one headgear interface connecting the mechanical assembly to a headgear.

The at least one mount assembly may include at least one height adjuster carriage slidably mounted to the at least one headgear interface.

The at least one mount assembly may include at least one height adjuster connected to the at least one height adjuster carriage. Actuation of the at least one height adjuster enables the at least one height adjuster carriage to move with respect to the at least one headgear interface.

The at least one tilt/flip assembly may include at least one tilt/flip knob connected to the at least one tilt/flip pin for manual rotation of the at least one tilt/flip pin.

The at least one tilt/flip pin may include a single tilt/flip pin and the at least one tilt/flip knob may include two tilt/flip knobs. Each of the two tilt/flip knobs is connected to an opposite end of the single tilt/flip pin.

The at least one tilt/flip pin may include two tilt/flip pins and the at least one tilt/flip knob may include two tilt/flip knobs. Each of the two tilt/flip knobs is connected to an end of one of the two tilt/flip pins.

The at least one tilt/flip assembly may include at least one tilt cam located inside of the at least one tilt/flip pin and connected to the at least one tilt/flip knob by a cam connection. The cam connection extends through at least one scissor plate such that rotation of the tilt cam causes pivoting movement of the at least one scissor plate.

The at least one scissor plate may include a scissor plate slot between the cam connection and a scissor pivot. The at least one tilt/flip pin may include an offset pin extending through the scissor plate slot such that pivoting movement of the at least one scissor plate causes the tilt/flip pin to rotate.

The at least one tilt/flip assembly may include a flip lock pin mounted to a lock pin carrier located inside of the tilt/flip pin.

An operational lock slot may extend through the at least one pivot cylinder such that the at least one pivot cylinder is locked in an operational position when the flip lock pin extends through the operational lock slot.

Movement of the lock pin carrier inward may align the flip lock pin with a flip slot on an inner surface of the tilt/flip pin, allowing the pivot cylinder to rotate around the tilt/flip pin to a stowed position.

The flip lock pin may be biased outwardly via a compression spring.

A fore/aft adjustment rail may extend from the at least one pivot cylinder. A base mount may be slidably connected to the fore/aft adjustment rail.

A pivoting mount may be rotatably connected to the base mount.

The at least one electro-optical assembly may be removably attached to the pivoting mount.

An offset adjuster screw may extend through the pivoting mount to the base mount such that rotation of the offset adjuster screw changes a length of a shank of the offset adjuster screw extending between the pivoting mount and the base mount, thereby rotating the pivoting mount and changing the angle of the pivoting mount relative to the base mount.

An IPD spring may extend between a first spring mount point on the base mount and a second spring mount point on the pivoting mount.

The IPD spring may change rotational force bias at an intermediary transition point between an operational position of the pivoting mount and a stow position of the pivoting mount.

### BRIEF DESCRIPTION OF THE SEVERAL VIEWS OF THE DRAWING

FIGS. 1a, 1b, 1c, and 1d illustrate front, side perspective, isolated side perspective, and front perspective views, respectively, of a headgear mount system.

FIGS. 2a, 2b, and 2c illustrate side perspective views of various embodiments of the headgear mount system.

FIG. 3 illustrates a side view of various positions of a portion of a tilt/flip assembly of an embodiment of the headgear mount system.

FIG. 4 illustrates a cross-sectional view of a portion of a tilt/flip assembly of an embodiment of the headgear mount system.

FIG. 5 illustrates a side perspective view of a portion of a tilt/flip assembly of an embodiment of the headgear mount system.

FIG. 6 illustrates a side perspective view of an embodiment of the headgear mount system with one of the electro-optical assemblies in a stowed position.

FIG. 7 illustrates a front view of various positions of a IPD adjustment assembly of an embodiment of the headgear mount system.

It should be understood that, for clarity, not all elements are labeled in all drawings. Lack of labeling in a figure should not be interpreted as lack of a feature.

### DETAILED DESCRIPTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

The headgear mount/goggle system is a new infantry headgear mount system for electro-optical goggles that combines the headgear mount and goggles into one design. This is done by using a mount point for each electro-optical assembly instead of a single mount point for both electro-optical assemblies connected by a bridge, this allows for increased user adjustability, lower profile stow, and the option for the user to stow each electro-optical assembly separately if desired.

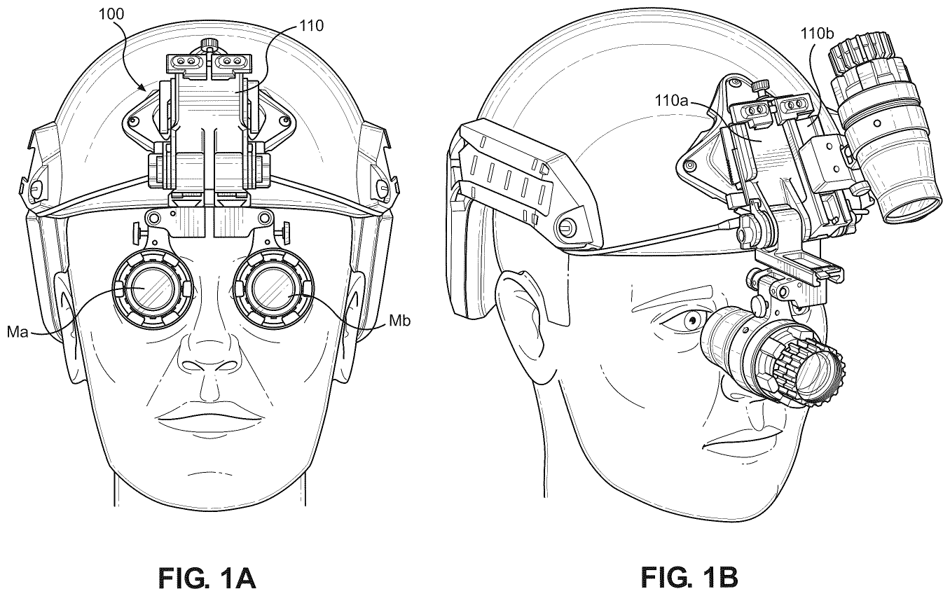

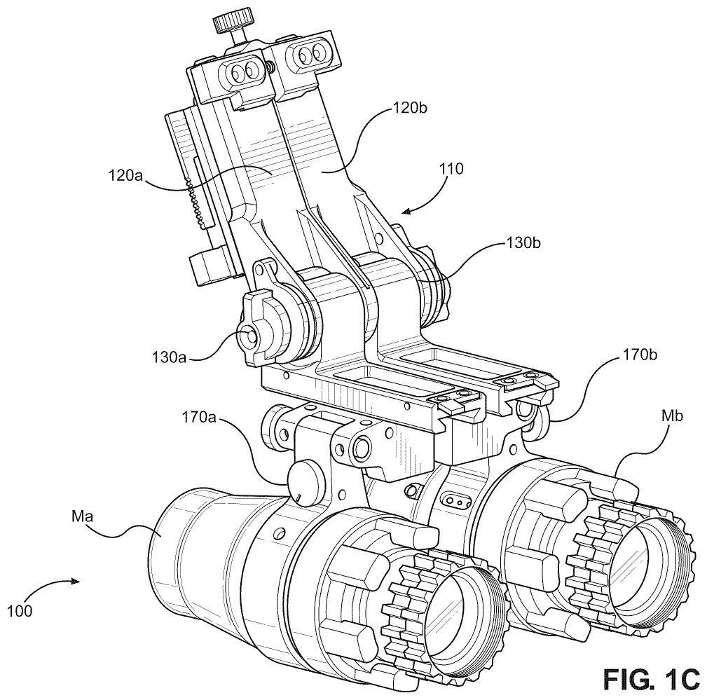

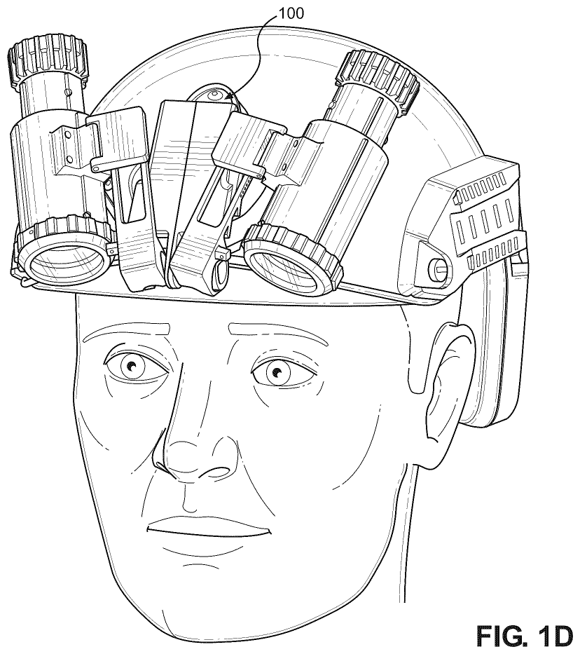

As seen in FIGS. 1a and 1b, the headgear mount system 100 includes a mechanical assembly 110. The mechanical assembly 110 include mechanical adjustment and mounting for two electro-optical assemblies Ma and Mb. When attached, mechanical assembly 110 effectively acts as a “bridge” to form a binocular goggle system. Power to the electro-optical assemblies Ma and Mb can be supplied from a battery pack mounted on the headgear and/or a small battery designed into the headgear mount, monocular adapters, or monoculars. The mechanical assembly 110 may have left and right elements with an identical or mirrored configuration and function, except where noted, and any description of an element on a first side may be assumed to apply to an element on a second side, again except where noted.

A system 100 shown in FIG. 1c with two electro-optical assemblies Ma and Mb incorporated into the headgear mount system 100, such that the system 100 acts as the “bridge”, and has all required adjustment mechanisms incorporated into the “bridge”. As shown on FIG. 1c, the mechanical assembly 110 effectively acts as a bridge, joining each electro-optical assembly Ma and Mb together to form a binocular goggle system. Moreover the system 100 incorporates all adjustments on prior art including optical alignment between the two electro-optical assemblies Ma and Mb.

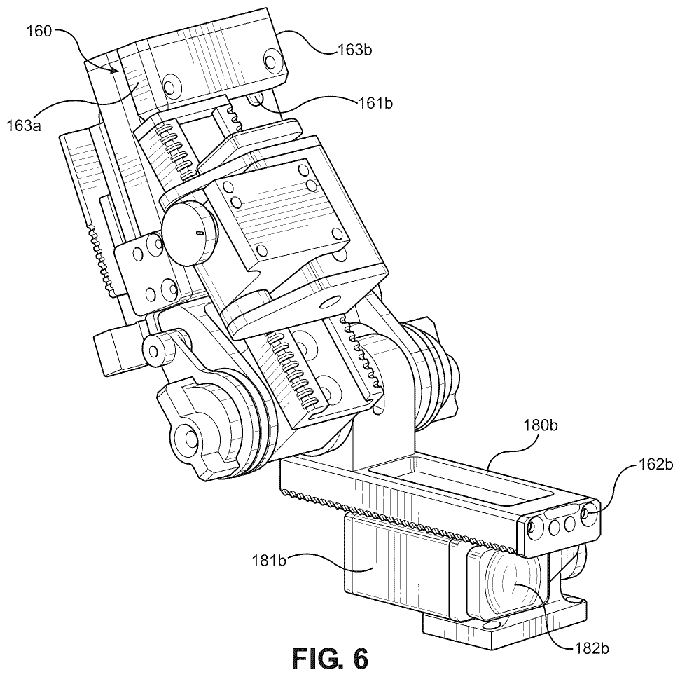

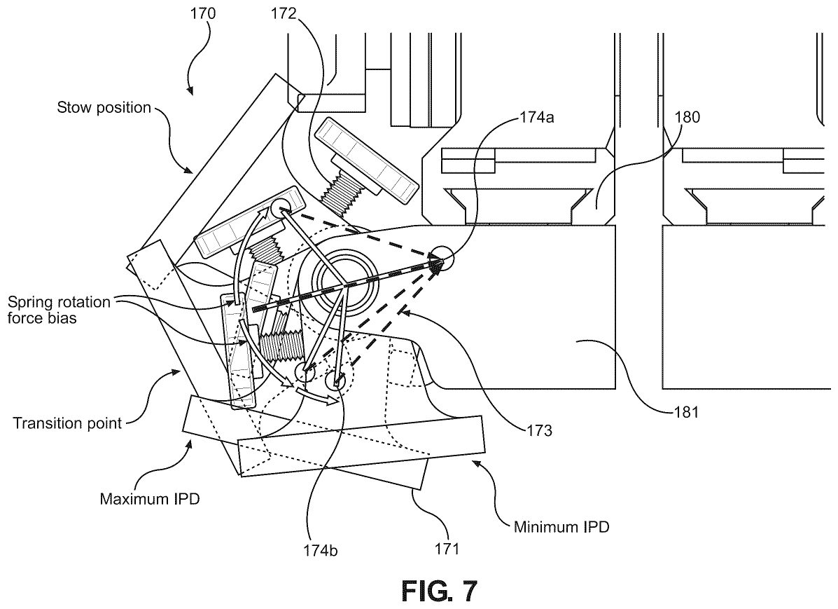

As shown in FIGS. 1b and 6, elements of the mechanical assembly 110 may be stowed separately or together. Separate stowing allows the user to quickly change from binocular vision to monocular vision in dynamic light situations where tube gain cannot adjust quickly enough. In other embodiments, this architecture could be used to make a “fused” system that utilizes different sensors in each of the electro-optical assemblies Ma and Mb, allowing the user to quickly switch between different sensing modes. By way of non-limiting example, one system 100 might use a low light sensor in the first electro-optical assembly Ma and a thermal sensor in the second electro-optical assembly Mb. Alternately, if a binocular approach is unnecessary, the second electro-optical assembly Mb could be omitted in certain cases to allow use of a monocular electro-optical assembly.

Separate stowing allows the architecture to lock one of the electro-optical assemblies Ma and Mb in the stow position which also moves the center of gravity back to help with user neck strain. Separate stowing also allows for each of the electro-optical assemblies Ma and Mb to be quickly removed and replaced by a take-down pin or similar design. Because the stow position does not have to be in the vertical orientation, various separate stowing embodiments also allow the stow position to be at an angle, as seen in FIG. 1d, or even off to the side of the helmet. Embodiments that do not allow separate stowing allow for easier, faster one-handed stowing of the mechanical assembly 110.

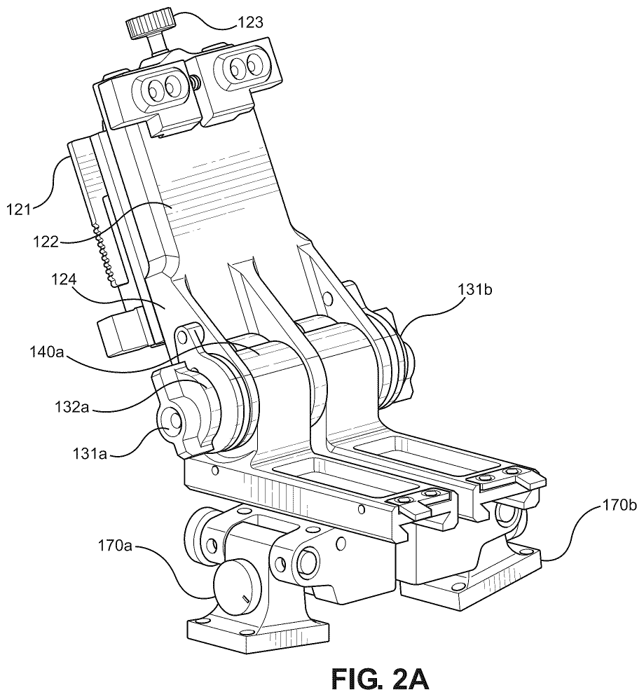

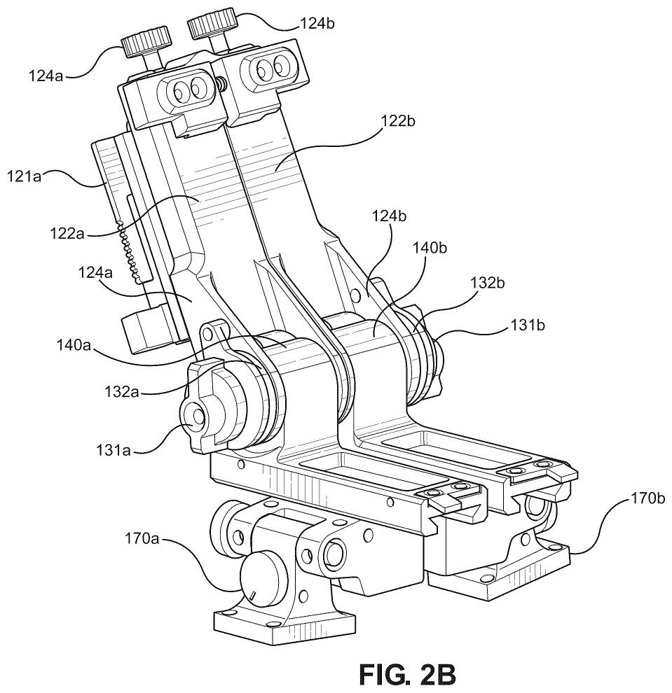

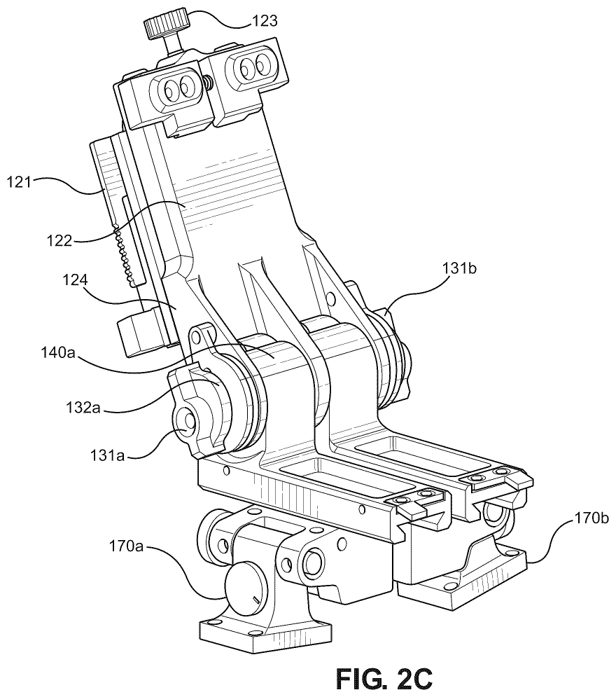

In FIG. 2b, the mechanical assembly 110 is removably connected to the headgear by a right mount assembly 120a and a left mount assembly 120b. Right mount assembly 120a includes at least one headgear interface 121a mounted to the headgear. The position of the right electro-optical assembly Ma with respect to the headgear is fully adjustable through a height adjuster carriage 122a movably mounted to the headgear interface 121a. Actuation of at least one height adjuster 123a enables motion of height adjuster carriage 122a. The height adjuster 123a allows adjustment of the electro-optical assembly Ma to account for any visual misalignment between the electro-optical assembly Ma and the user's horizon. This allows for ultimate adjustability for the user. As seen in FIGS. 2a and 2c, certain embodiments only have a single mount assembly 120, headgear interface 121, height adjuster carriage 122, and height adjuster 123 for a simpler and faster height adjustment.

In one embodiment, the height adjuster carriage 122a is locked in place and may be manually moved by a user along the headgear interface 121a upon user actuation of the height adjuster 123a. In such an embodiment, the height adjuster 123a by be a friction lock release or a toothed lock release. In another embodiment, the height adjuster carriage 122a may be manually moved by a user along the headgear interface 121a until user actuation of the height adjuster 123a. In such an embodiment, the height adjuster 123a by be a friction lock or a toothed lock. In another embodiment, the height adjuster carriage 122a may slide along the headgear interface 121a based on user rotation of the height adjuster 123a. Rotation of the height adjuster 123a in a first direction moves the height adjuster carriage 122a linearly in a first direction along the headgear interface 121a to increase the height of the electro-optical assembly Ma. Rotation of the height adjuster 123a in a second direction moves the height adjuster carriage 122a linearly in a second direction along the headgear interface 121a to decrease the height of the electro-optical assembly Ma.

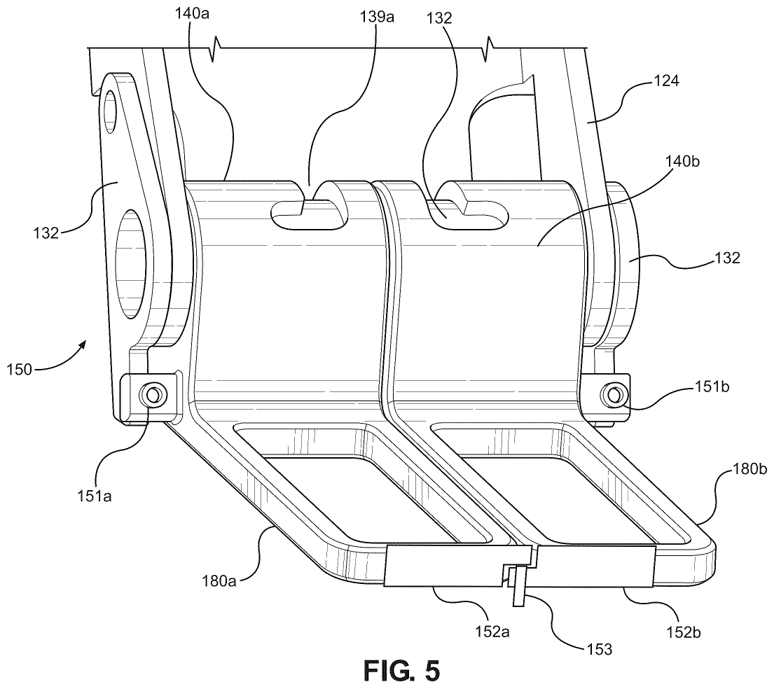

As shown in FIGS. 1c and 2a-2c, a tilt/flip assembly 130a allows flip, the rotation of the electro-optical assemblies Ma and Mb around an axis extending across a user's face. A tilt/flip knob 131a is connected to a tilt/flip pin 132a that is coaxial with the axis of flip rotation. The tilt/flip pin 132a also interconnects the mount assembly 120a and a pivot cylinder 140a, allowing the electro-optical assembly Ma (and the IPD adjustment assembly 170a, if used) to be rotated with respect to the mount assembly 120a. As seen in FIGS. 2a and 2b, certain embodiments include independent tilt/flip assemblies 130a and 130b to allow adjustable dip-vergence in collimation, which allows the user to adjust the tilt of each side until the image is visually aligned or mechanically adjusted. As seen in FIGS. 2c and 5, certain embodiments only have a single tilt/flip pin 132 which allows for factory set goggle dip-vergence collimation adjustment. The right and left tilt/flip knob 131a and 131b still allow independent rotation of the respective electro-optical assemblies Ma and Mb, and the IPD adjustment assemblies 170a and 170b. The tilt/flip assembly 130a may include a pin-and-cylinder mechanism, ball-and-socket mechanism, or multi-point linkage mechanism.

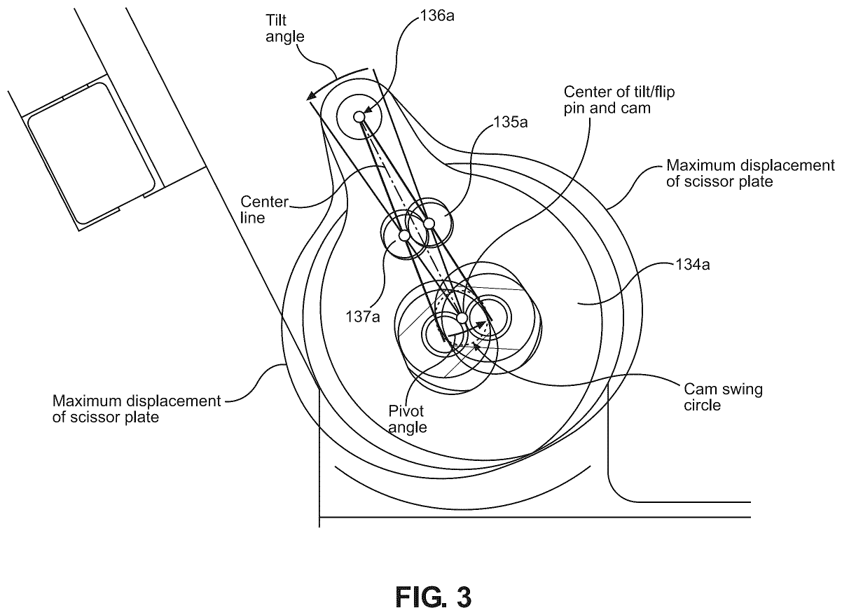

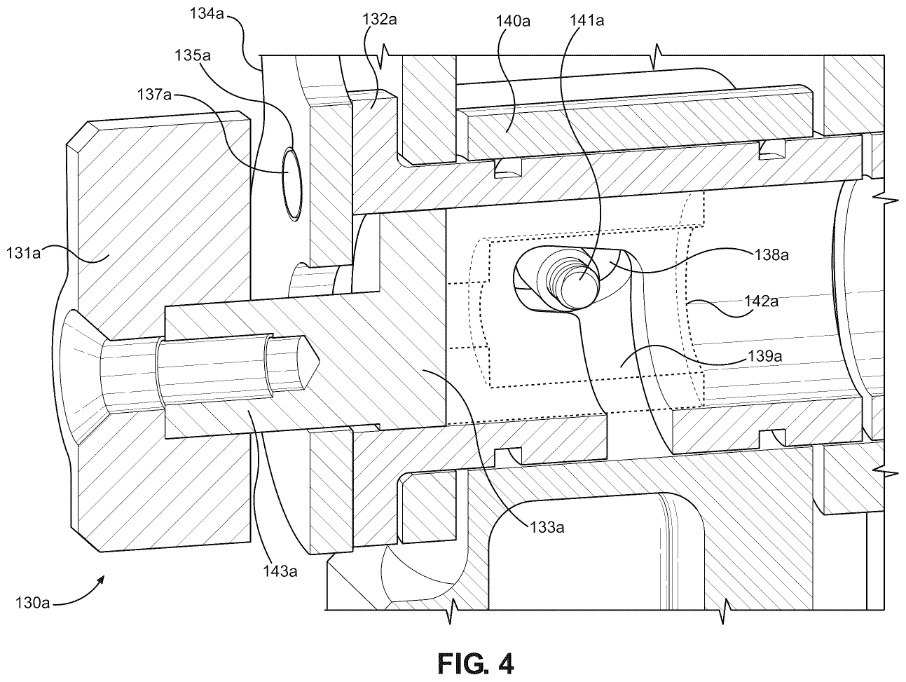

As shown in FIGS. 3 and 4, the tilt/flip assembly 130a combines tilt adjustment and operational position lock/release into the same adjustment point. This reduces the number of adjustment points the user is required to utilize. Tilt is adjusted by rotating the tilt/flip knob 131a which rotates the tilt/flip pin 132a and a center of a tilt cam 133a, in turn swinging a scissor plate 134a around its pivot point in scissor pivot 136a. The scissor plate 134a has a scissor plate slot 135a between the tilt cam 133a and the scissor pivot 136a which creates side movement at the scissor plate slot 135a relative to a center line. The tilt/flip pin 132a has an offset pin 137a that fits in the scissor plate slot 135a, which when moved by the scissor plate 134a causes the tilt/flip pin 132a to rotate around its axis because the tilt/flip pin 132a is axially constrained from moving laterally by the height adjuster carriage 122. Essentially, a cam connection 143a extends through the scissor plate 135a such that rotation of the tilt cam 133a causes a pivoting movement of the scissor plate 135a. In certain embodiments, the tilt/flip assembly 130a may incorporate different cam types and linkage mechanisms, as well as screws or worm gears.

The tilt/flip assembly 130a incorporates a pin-in-slot approach and is operated by pushing in the tilt/flip knob 131a. This mechanism only locks the mount in the operational position, while a stow lock is part of a separate locking assembly 160. The tilt/flip assembly 130a shown in FIG. 4 has only two slots, an elongated operational lock slot 138a in a pivot cylinder 140a and an L-shaped flip slot 139a in the tilt/flip pin 132a. The pivot cylinder 140a is locked in the operational position when a flip lock pin 141a is allowed to fall into the operational lock slot 138a. The flip lock pin 141a is mounted to the lock pin carrier 142a located inside of the tilt/flip pin 132a. The flip lock pin 141a is biased outward via a compression spring, while the scissor plate 134a or the flip lock pin 141a are used to retain the tilt/flip assembly 130a in place in the system 100. The tilt cam 133a is attached to the lock pin carrier 142a along the same axis, allowing the tilt cam 133a to rotate for tilt adjustment and the lock pin carrier 142a to be moved laterally without affecting the tilt adjustment. When the lock pin carrier 142a is moved inward the flip lock pin 141a aligns with the flip slot 139a, allowing the pivot cylinder 140a to rotate around the tilt/flip pin 132a to the stowed position; the lock pin carrier 142a stays in the inward position until the pivot cylinder 140a is rotated back to the operational position. This would adjust the tilt when the goggle is flipped to the stow position as the lock pin carrier 142a is designed to rotate with the pivot cylinder 140a which would rotate the tilt cam 133a. Other embodiments contemplated may add an “anti-rotation” insert between the lock pin carrier 142a and the tilt cam 133a, or reverse the roles of the slots so the flip slot 139a is in the pivot cylinder 140a instead of in the tilt/flip pin 132a, as shown in FIG. 5.

As shown in FIG. 5, certain embodiments may use a mechanical adjuster 150 to set optical dip-vergence alignment. One embodiment uses a single tilt/flip pin 132 with at least one reference feature 151 that the tilt/flip assembly 130 stops on. Alignment can be adjusted with a screw, shim, or similar design. Another embodiment uses alignment references 152a and 152b from one fore/aft adjustment rail 180a to the other fore/aft adjustment rail 180b, with an adjustment mechanism 153 selected from a screw, shim, or similar mechanism for adjustment.

As shown in FIG. 6, certain embodiments include a locking assembly 160 to hold the electro-optical assemblies Ma and Mb in the stow position, such that the stow angle is independent from the tilt adjustment. The height adjuster carriage 122 has at least one spring-loaded plunger 161 attached to it; the fore/aft adjustment rails 180 have at least one corresponding detent hole 162. The spring-loaded plunger 161 will “nap into the detent hole 162 to hold the stowed position. An additional external force is required to move overcome the spring force of the spring-loaded plunger 161 to move it into the operational position. Since the relational stow angle is created by the height adjuster carriage-to-fore/aft assembly instead of height adjuster carriage-to-tilt pin-to-fore/aft assembly, eliminating the tilt pin relationship, the stow angle is the same despite the tilt angle adjustment. Certain embodiments may use a spring-loaded latch 163 or similar locking mechanism if a more positive lock is required to prevent unintended de-latching, such as, but not limited to, when the system 100 is subjected in increased G-forces. Other embodiments may use spring loaded latches, detents, screws, and/or frictional locks to hold the electro-optical assemblies Ma and Mb in the stow position.

At least one fore/aft adjustment rail 180 extends from the pivot cylinder 140. A base mount 181 is slidably connected to the fore/aft adjustment rail 180, allowing a user to increase or decrease the distance between the base mount 181 and their eye. Upon actuation or release of a fore/aft lock 182, depending upon the embodiment, the user may adjust the distance, similarly to the height adjuster 123a. Distance adjustment may be discrete or continuous.

The IPD adjustment assembly 170 includes a pivoting mount 171 rotatably connected to the base mount 181. The electro-optical assembly M is removably attached to the pivoting mount 171. An offset adjuster screw 172 extends through the pivoting mount 171 to the base mount 181 such that rotation of the offset adjuster screw 172 changes IPD. Rotation increases or decreases the length of the shank of the offset adjuster screw 172 extending between the pivoting mount 171 and the base mount 181, thereby rotating the pivoting mount 171 and changing the angle of the pivoting mount 171 (and attached electro-optical assembly M) relative to the base mount 181.

Operational position and stow position of the pivoting mount 171 are retained by the help of an IPD spring 173 that changes rotational force bias at an intermediary transition point between the operational and stow positions as shown in FIG. 5. The IPD spring 173 is a tension spring extending between at a first spring mount point 174a on the base mount 181 and a second spring mount point 174b on the pivoting mount 171. In the operational position, the IPD spring 173 biases the pivoting mount 171 such that the adjuster screw 172 contacts the base mount 181. In the stowed position, the IPD spring 173 biases the pivoting mount 171 such that the adjuster screw 172 is moved away from contacting the base mount 181. Other spring designs or mechanisms known to those skilled in the art that apply a similar rotation force bias may also be used.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A headgear mount system comprising:
a mechanical assembly comprising at least one mount assembly and at least one tilt/flip assembly,
wherein the at least one mount assembly connects the mechanical assembly to a headgear,
wherein the at least one tilt/flip assembly rotatably connects to at least one electro-optical assembly,
wherein the at least one tilt/flip assembly comprises at least one tilt/flip pin interconnecting the at least one mount assembly and the at least one electro-optical assembly,
wherein the at least one tilt/flip pin extends through at least one carriage connector of the at least one mount assembly and at least one pivot cylinder connected to the at least one electro-optical assembly.

2. The system of claim 1, wherein the at least one mount assembly comprises a right mount assembly and a left mount assembly.

3. The system of claim 1, wherein the at least one mount assembly comprises at least one headgear interface connecting the mechanical assembly to a headgear.

4. The system of claim 3, wherein the at least one mount assembly further comprises at least one height adjuster carriage slidably mounted to the at least one headgear interface.

5. The system of claim 4, wherein the at least one mount assembly further comprises at least one height adjuster connected to the at least one height adjuster carriage whereby actuation of the at least one height adjuster enables the at least one height adjuster carriage to move with respect to the at least one headgear interface.

6. The system of claim 1, wherein the at least one tilt/flip assembly further comprises at least one tilt/flip knob connected to the at least one tilt/flip pin for manual rotation of the at least one tilt/flip pin.

7. The system of claim 6, wherein the at least one tilt/flip pin comprises a single tilt/flip pin and the at least one tilt/flip knob comprises two tilt/flip knobs, wherein each of the two tilt/flip knobs is connected to an opposite end of the single tilt/flip pin.

8. The system of claim 6, wherein the at least one tilt/flip pin comprises two tilt/flip pins and the at least one tilt/flip knob comprises two tilt/flip knobs, wherein each of the two tilt/flip knobs is connected to an end of one of the two tilt/flip pins.

9. The system of claim 1, wherein the at least one tilt/flip assembly comprises at least one tilt cam located inside of the at least one tilt/flip pin and connected to the at least one tilt/flip knob by a cam connection, wherein the cam connection extends through at least one scissor plate such that rotation of the tilt cam causes pivoting movement of the at least one scissor plate.

10. The system of claim 9, wherein the at least one scissor plate comprises a scissor plate slot between the cam connection and a scissor pivot, and the at least one tilt/flip pin comprises an offset pin extending through the scissor plate slot such that pivoting movement of the at least one scissor plate causes the tilt/flip pin to rotate.

11. The system of claim 1, wherein the at least one tilt/flip assembly further comprises a flip lock pin mounted to a lock pin carrier located inside of the tilt/flip pin.

12. The system of claim 11, wherein an operational lock slot extends through the at least one pivot cylinder such that the at least one pivot cylinder is locked in an operational position when the flip lock pin extends through the operational lock slot.

13. The system of claim 12, wherein movement of the lock pin carrier inward aligns the flip lock pin with a flip slot on an inner surface of the tilt/flip pin, allowing the pivot cylinder to rotate around the tilt/flip pin to a stowed position.

14. The system of claim 11, wherein the flip lock pin is biased outwardly via a compression spring.

15. The system of claim 1, further comprising a fore/aft adjustment rail extending from the at least one pivot cylinder and a base mount slidably connected to the fore/aft adjustment rail.

16. The system of claim 15, further comprising a pivoting mount rotatably connected to the base mount.

17. The system of claim 16, wherein the at least one electro-optical assembly is removably attached to the pivoting mount.

18. The system of claim 16, wherein an offset adjuster screw extends through the pivoting mount to the base mount such that rotation of the offset adjuster screw changes a length of a shank of the offset adjuster screw extending between the pivoting mount and the base mount, thereby rotating the pivoting mount and changing the angle of the pivoting mount relative to the base mount.

19. The system of claim 16, further comprising an IPD spring extending between a first spring mount point on the base mount and a second spring mount point on the pivoting mount.

20. The system of claim 19, wherein the IPD spring changes rotational force bias at an intermediary transition point between an operational position of the pivoting mount and a stow position of the pivoting mount.
